(19) United States
(12) Patent Application Publication
(10) Pub. No.: US 2015/0363749 A1
(43) Pub. Date: Dec. 17, 2015

(54) SYSTEM AND METHOD FOR CHECKOUT AND RETURN OF PORTABLE ELECTRONIC DEVICES FROM A KIOSK

(71) Applicant: JAVA CONNECTIONS, LLC, DALLAS, TX (US)

(72) Inventors: Matthew Buscher, South San Francisco, CA (US); Jonathan Ruttenberg, Dallas, TX (US); Daniel Aspenwall, Winthrop, WA (US)

(21) Appl. No.: 14/305,824

(22) Filed: Jun. 16, 2014

(51) Int. Cl. G06Q 10/00; G06Q 20/18; G06Q 30/06

(52) U.S. Cl. CPC G06Q 10/20; G06Q 30/0645; G06Q 20/18

(57) ABSTRACT

A method includes receiving a previously dispensed portable electronic device from a user by a vending kiosk. In addition, the method includes storing the received portable electronic device in the vending kiosk. The method further includes determining an elapsed time between a time that the portable electronic device was previously dispensed and a time of receiving the portable electronic device, and when the elapsed time is less than a threshold, displaying a return user interface for indicating a problem with the portable electronic device.

### CROSS-REFERENCE TO RELATED APPLICATION AND PRIORITY CLAIM

This application claims priority under 35 U.S.C. §119(e) to U.S. Provisional Patent Application No. 61/837,041 filed on Jun. 19, 2013. This provisional patent application is hereby incorporated by reference in its entirety.

### TECHNICAL FIELD

The present disclosure is directed, in general, to automated checkout kiosks.

### BACKGROUND OF THE DISCLOSURE

Automated kiosks can dispense a rental product. Improved automated kiosks are desirable.

### SUMMARY OF THE DISCLOSURE

Various disclosed embodiments include systems and methods for checkout and return of portable electronic devices from a kiosk.

In a first embodiment, a method includes, at a vending kiosk, receiving a previously dispensed portable electronic device from a user. In addition, the method includes storing the received portable electronic device. The method further includes, in response to an elapsed time between a time that the portable electronic device was previously dispensed and a time of receiving the portable electronic device satisfying a threshold, displaying a return user interface for indicating a problem with the portable electronic device.

In a second embodiment, an apparatus includes at least one processing device configured to receive a previously dispensed portable electronic device from a user. The at least one processing device is also configured to store the received portable electronic device. The at least one processing device is further configured, in response to an elapsed time between a time that the portable electronic device was previously dispensed and a time of receiving the portable electronic device satisfying a threshold, to display a return user interface for indicating a problem with the portable electronic device.

In a third embodiment, a non-transitory computer readable storage medium includes instructions that, when executed by at least one processing device, cause the at least one processing device to receive a previously dispensed portable electronic device from a user. The non-transitory computer readable storage medium also includes instructions that, when executed by the at least one processing device, cause the at least one processing device to store the received portable electronic device. The non-transitory computer readable storage medium also includes instructions that, when executed by the at least one processing device, cause the at least one processing device to, in response to an elapsed time between a time that the portable electronic device was previously dispensed and a time of receiving the portable electronic device satisfying a threshold, to display a return user interface for indicating a problem with the portable electronic device.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a diagram of an illustrative kiosk for checking out and returning devices according to disclosed embodiments;

FIG. 2 illustrates a display of an exemplary user interface for checking out and returning devices according to disclosed embodiments;

FIG. 3 illustrates a display of an exemplary transaction receipt according to disclosed embodiments;

FIG. 4 illustrates a display of an exemplary user interface for reporting a problem with a returned device according to disclosed embodiments;

FIG. 5 illustrates a display of an exemplary user interface illustrating administrator configuration options according to disclosed embodiments;

FIGS. 6-6C illustrate displays of changed configuration items according to disclosed embodiments;

FIG. 7 illustrates a display of an exemplary user interface illustrating a changed configuration item according to disclosed embodiments;

FIG. 8 illustrates a display of a photo archive feature of the kiosk for checking out and returning devices according to disclosed embodiments;

FIG. 9 illustrates a simplified block diagram of a portion of a kiosk according to disclosed embodiments; and

FIG. 10 illustrates a flowchart of a process according to disclosed embodiments.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Automated kiosks can dispense a purchased product or a rental product. Such kiosks can be software driven through microprocessors and include various input and output devices such as a touchscreen, a credit card reader, and a paper printer. During a rental transaction, a user or renter enters their credentials (e.g., username/password; credit card information; etc.) to start a rental. Upon approval of the user's credentials, the kiosk then dispenses the product. When the user finishes and re-inserts the product into the kiosk, payment is made and the rental is complete. A receipt is then delivered to the customer. However, the ability of the user to indicate that a problem was encountered with the product to the vendor is limited. Accordingly, improved automated kiosks are desirable.

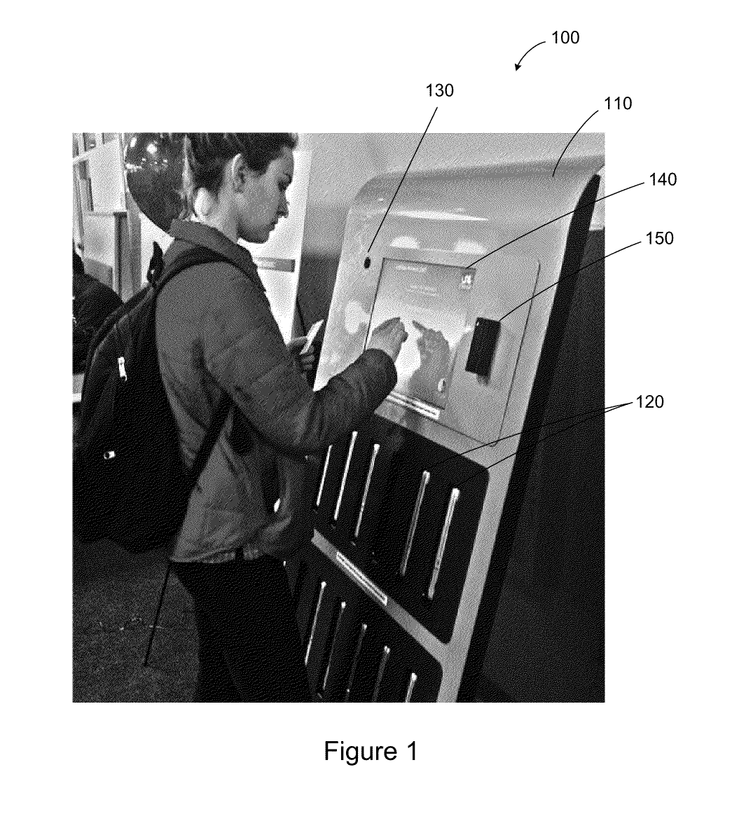

FIG. 1 depicts a diagram of a portable electronic device checkout and return system 100. The system 100 comprises a vending kiosk 110 equipped with a control system operable for securely storing, recharging, wiping clean, and selectively dispensing portable electronic devices. The vending kiosk 110 is preferably configured and arranged for self-checkout of portable electronic devices, such as a portable internet tablet, a portable e-reader, a portable tablet computer, a portable laptop computer, a cellular telephone, a personal digital assistant (PDA), a smartphone, or a consumer electronics device comprising various combinations thereof.

The vending kiosk 110 includes a processor (not shown), a plurality of shelves or slots 120 each configured and arranged to hold a portable electronic device, a camera 130 such as a webcam, and a user interface 140 including a display such as a touchscreen, a keypad, or a keyboard that facilitates interaction with a user. The processor (not shown) can communicate with an administrator, an inventory management system, etc. and interface with a user or renter to allow an organized check-in and/or checkout of the devices.

A portable electronic device that rests on a shelf or that is inserted into a slot 120 in the kiosk 110 can be locked, charged, and wiped clean. A portable electronic device can be dispensed or unlocked when an authorized user or renter checks out the portable electronic device. Each shelf or slot 120 can contain a charging apparatus to charge a portable electronic device that rests on the shelf or that is inserted into the slot 120. The kiosk 110 can contain reader such as a card reader or a bar code reader 150 for obtaining a renter's credentials, and a receipt printer (not shown) to print a receipt of the renter's transaction, such as an identification of the portable electronic device checked out, an identification of the time that the portable electronic device was checked out or checked in, an identification of the duration and cost of the rental, etc.

Each portable electronic device can be surrounded by a hard plastic cover or case that protects the portable electronic device from damage. The case preferably also includes the electrical components for charging and identifying the portable electronic device.

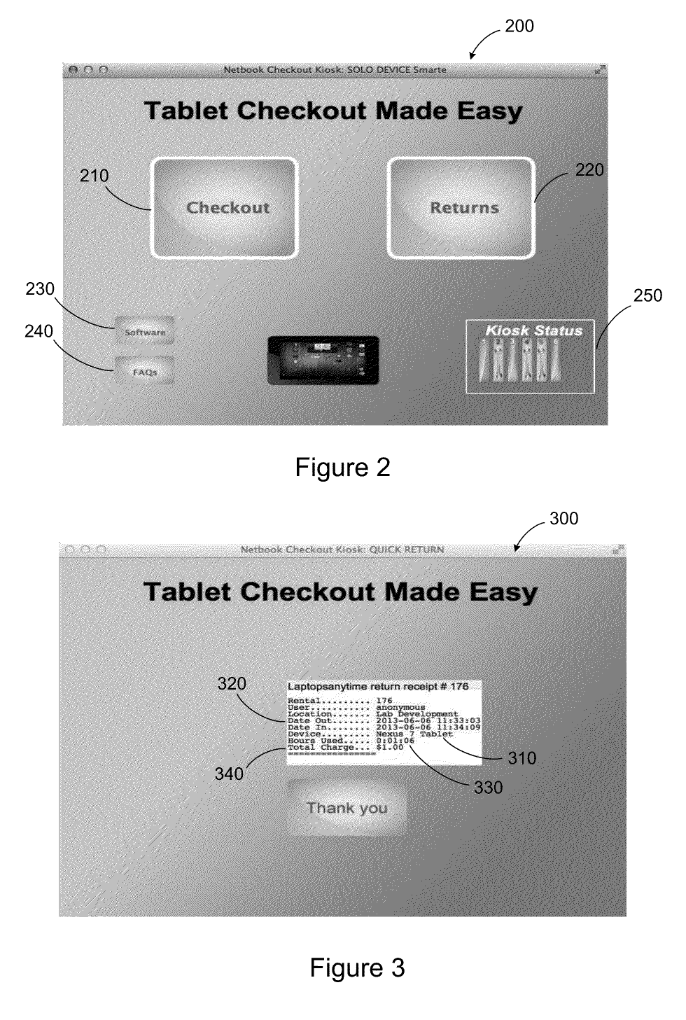

FIG. 2 illustrates a display of an exemplary user interface 200 for checking out and returning portable electronic devices. In the exemplary embodiment, the interface 200 includes a checkout application 210, a return application 220, a software application 230, a frequently asked questions (FAQs) application 240, and a kiosk status application 250. The checkout application 210 can be used when the user wishes to checkout a portable electronic device. The return application 220 can be used when the user is finished with the portable electronic device and wishes to complete the rental and return the portable electronic device to the kiosk 110. The software application 230 can be used when the user wishes to determine what type of software is included in the portable electronic device to be rented. The FAQs application 240 can be used when the user wishes to see answers to frequently asked questions. The kiosk status application 250 can be used to determine an operational status of the kiosk. More or fewer applications may be included in the user interface 200.

To use the system 100, the user or renter enters their credential information to start a rental. For example, the user can enter a membership number, driver's license number, credit card number, etc. via the user interface 140 of FIG. 1. Alternatively, the user may have a credential card read by the reader 150, such as by swiping a membership card or credit card through the reader 150, or by placing the membership card or the credit card under the reader 150, etc. The processor may transmit the credential information wirelessly or through a modem by conventional telephone lines to the administrator or the inventory management system and may await receipt of a signal indicating that the identified user is authorized to checkout one of the portable electronic devices. When the user's credentials are verified, the kiosk 110 ejects the portable electronic device and the user removes the portable electronic device for use. When the user finishes using the portable electronic device, the user performs a check-in process where the portable electronic device is received and/or identified by the kiosk 110 (e.g., inserted into and/or scanned by the kiosk 110) and stored by the kiosk 110. At that time the rental is complete and the kiosk 110 is configured to print a receipt via a paper printer of the renter's transaction and/or display a copy of the receipt of the renter's transaction as illustrated in FIG. 3. In an exemplary embodiment, the portable electronic device is checked out from and checked in to the same kiosk. Alternatively, the portable electronic device may be returned (e.g., checked in) to a different kiosk than the kiosk from which it was originally checked out.

Although FIG. 2 illustrates one example of a user interface 200, various changes may be made to FIG. 2. For example, the layout and arrangement of the user interface are for illustration only. In general, this type of information can be presented in a number of formats.

FIG. 3 illustrates a display of an exemplary transaction receipt 300 according to disclosed embodiments. In the exemplary embodiment, the receipt 300 includes an identification 310 of the portable electronic device that was checked out, an identification 320 of the date and time that the portable electronic device was checked out and checked in, an identification 330 of the duration of the rental, and an identification 340 of the cost of the rental.

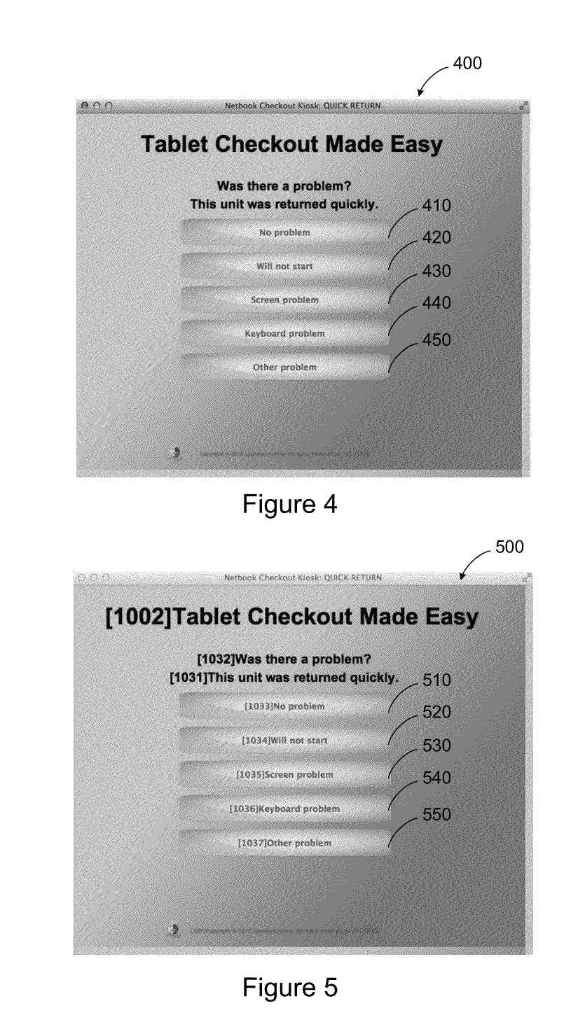

The kiosk 110 is configured to interpret a device checkout that is quickly followed by a return to indicate a possible problem with the portable electronic device (e.g., a “quick return” feature). In that case the kiosk 110 is configured to present a return user interface to the user such as the quick return user interface 400 illustrated in FIG. 4, asking the user to report any problems before presenting the return receipt illustrated in FIG. 3. For example, as illustrated in FIG. 3, the total time that the portable electronic device was checked out was one minute and six seconds. The kiosk 110 may interpret the relatively short rental time as an indication that there is a problem with the portable electronic device depending on configuration settings of the system set by the administrator, such as a threshold time of rental.

Although FIG. 3 illustrates one example of a transaction receipt 300, various changes may be made to FIG. 3. For example, the layout and arrangement of the transaction receipt 300 are for illustration only. In general, this type of information can be presented in a number of formats.

FIG. 4 illustrates a display of an exemplary quick return user interface 400 for reporting a problem with a returned device. As illustrated in FIG. 4, the quick return user interface 400 asks the user if there was a problem based on the portable electronic device being returned so quickly. In the exemplary embodiment, the quick return user interface 400 provides the user with a choice of responses from which to choose, such as “no problem” 410, “will not start” 420, “screen problem” 430, “keyboard problem” 440, and “other problem” 450. More or fewer problems may be included in the user interface 400. If there was a problem with the portable electronic device, the user may indicate such by choosing the corresponding response. For example, if the portable electronic device would not start or power up, the user may indicate such by choosing the “will not start” response 420. Similarly, if there was a problem with the keyboard of the portable electronic device, the user may indicate such by choosing the “keyboard problem” response 440.

Depending on the configuration settings, a user reporting a problem may result in the kiosk 110 sending an email notification to the administrator and blocking the portable electronic device indicated from future rentals. In this way, faulty portable electronic devices may be kept away from users and the administrator can plan maintenance.

Although FIG. 4 illustrates one example of a user interface 400, various changes may be made to FIG. 4. For example, the layout and arrangement of the user interface 400 are for illustration only. In general, this type of information can be presented in a number of formats.

FIG. 5 illustrates a display of an exemplary administrator configuration options user interface 500 illustrating administrator configuration options that allow an administrator to customize the quick return interface 400 of FIG. 4. In an exemplary embodiment, the choice of configuration items in the administrator configuration options user interface 500 corresponds to the choice of responses in the quick return interface 400 of FIG. 4. For example, the administrator configuration options user interface 500 includes the option “no problem” 510 that corresponds to the configuration item 1033, the option “will not start” 520 that corresponds to the configuration item 1034, the option “screen problem” 530 that corresponds to the configuration item 1035, the option “keyboard problem” 540 that corresponds to the configuration item 1036, and the option “other problem” 550 that corresponds to the configuration item 1037. If the administrator wishes to change a configuration item, the administrator may do so by choosing the corresponding option in the administrator configuration options user interface 500.

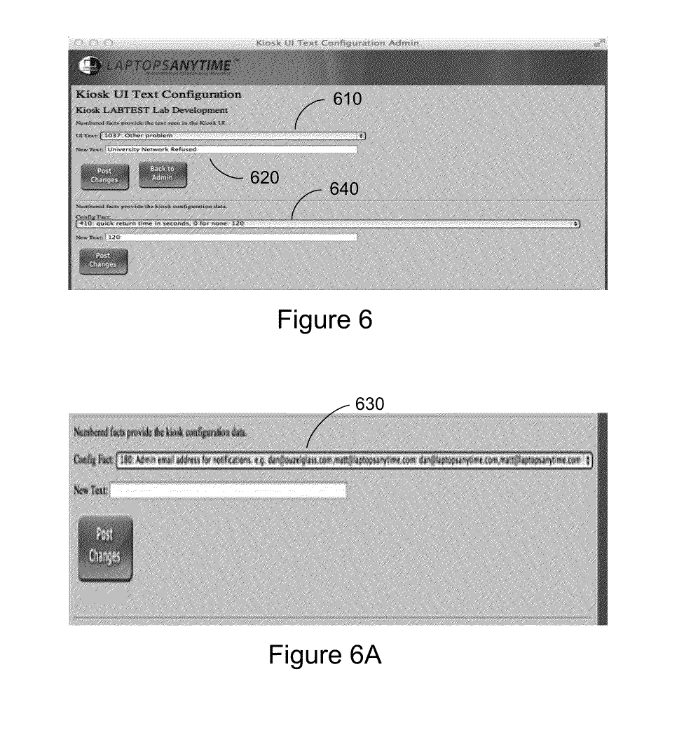

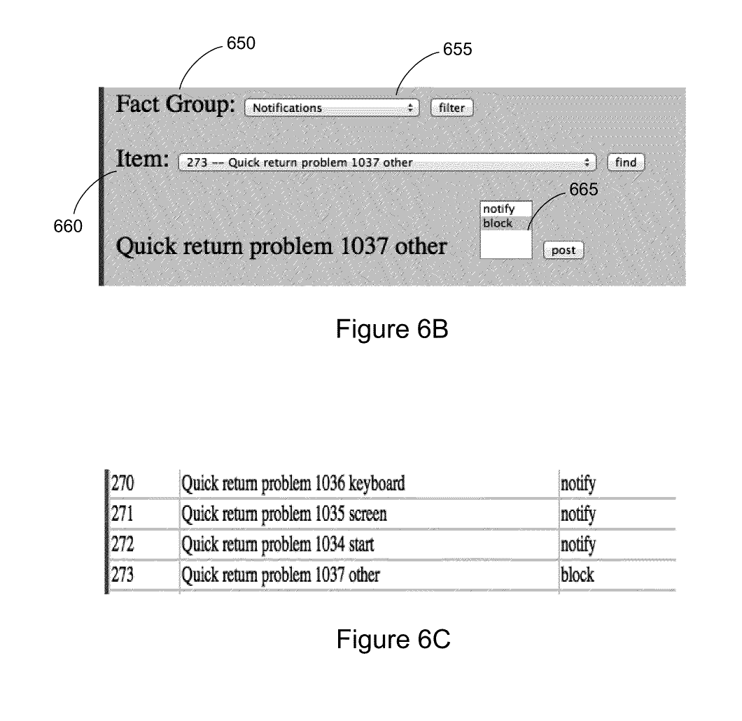

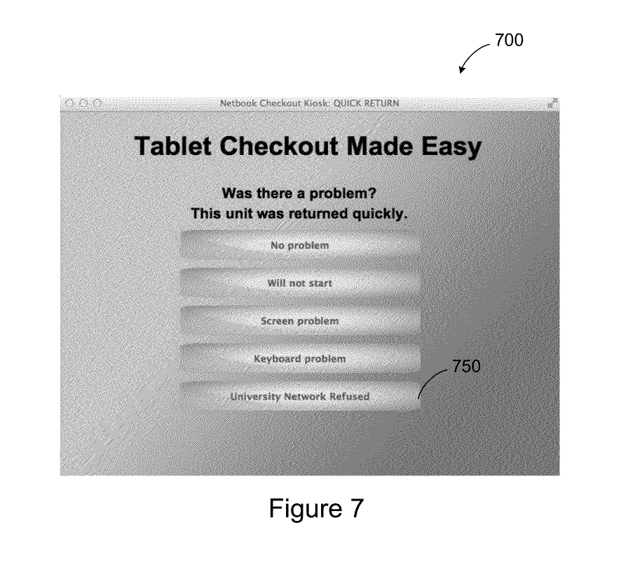

To illustrate, as illustrated by reference numeral 610 in FIG. 6, the administrator may change the configuration item 1037 (e.g., by choosing the “other problem” 550 configuration option of FIG. 5) so that a different response choice appears in the quick return user interface 400 of FIG. 4, such as “university network refused” as illustrated by reference numeral 620. After changing the configuration, the kiosk 110 is configured to display the changed configuration item 1037 that includes the “university network refused” response. For example, as illustrated in FIG. 7, which illustrates a display of an exemplary changed configuration user interface 700, the “other problem” 450 choice that was originally contained in the quick return user interface 400 of FIG. 4 has been changed to the “university network refused” 750 choice of FIG. 7.

Configuration options allow the administrator to choose email destinations for notifications, to choose the problems to be reported, to choose whether to block the portable electronic device from future rental until the portable electronic device has been serviced, or to just notify the administrator. For example, in an exemplary embodiment, the administrator may choose email addresses for notifications via a comma separated list in configuration item 180, such as illustrated by reference numeral 630 in FIG. 6A. In an exemplary embodiment, the comma separated list may be represented by source code as follows:
initFact(180, ‘dan@ouzelglass.com,matt@laptopsanytime.com’);

A threshold value for a quick return may be set in seconds in configuration item 410, as illustrated by reference numeral 640 in FIG. 6. In a particular embodiment, setting this threshold value to zero will suppress the quick return feature described above. In an exemplary embodiment, the threshold value for a quick return may be represented by source code as follows:

initFact(410, ‘120’); //quick return time in seconds. 0=ignore quick returns.

Each of the responses of the quick return interface can be configured to send a notification email to the administrator and optionally to block the portable electronic device from future rental until the portable electronic device has been serviced. The notification email may be associated with a fact group configuration item 650 comprising “Notifications” 655 as illustrated in FIG. 6B. The notifications 655 may be associated with a problem notification configuration item 660 for each of the responses of the quick return interface. In the example illustrated in FIG. 6B, each of the responses can be configured to send the notification email and to optionally block the portable electronic device from future rental by a drop down menu 665.

To illustrate, as shown in FIG. 6C, the problem notification configuration item 270 may be associated with the keyboard problem configuration item 1036 of FIG. 5, the problem notification configuration item 271 may be associated with the screen problem configuration item 1035 of FIG. 5, the problem notification configuration item 272 may be associated with the start problem configuration item 1036 of FIG. 5, and the problem notification configuration item 273 may be associated with the other problem configuration item 1037 of FIG. 5.

In the example illustrated in FIG. 6C, the “keyboard” (e.g., 1036), “screen” (e.g., 1035) and “start” (e.g., 1034) problems will notify the administrators and will not block the portable electronic device from future rentals. The “other problem” (e.g., 1037) problem will notify the administrators and will block the portable electronic device from future rentals. If the portable electronic device is blocked, administrators can eject and repair the portable electronic device and thereafter unblock the portable electronic device and return it to service.

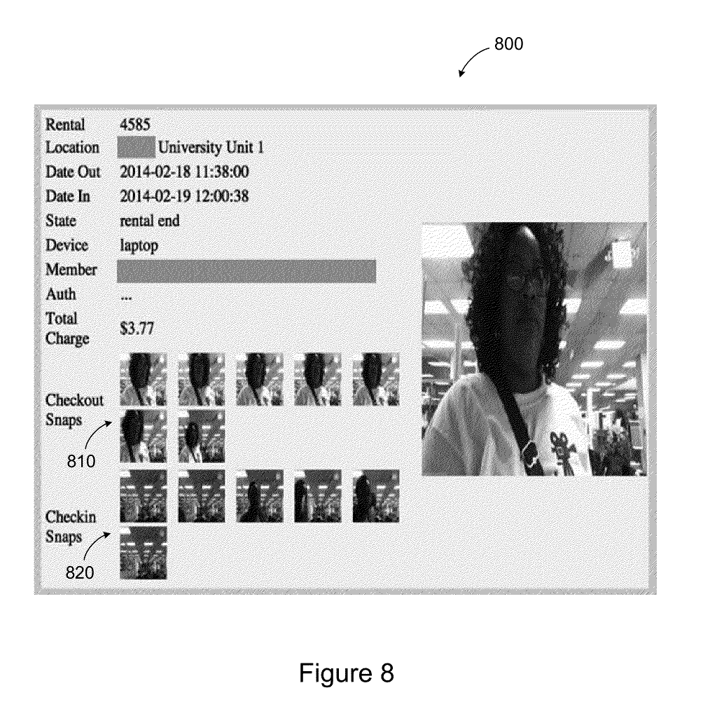

FIG. 8 illustrates a display 800 of a photo archive feature of the kiosk 110 for checking out and returning devices. This feature provides security for the rental devices by obtaining a photographic record of users from the kiosk camera 130 whenever a portable electronic device is ejected (e.g., checked out) or returned. When the portable electronic device is being checked out, the photo archive feature stores images (e.g., photos and/or video) of a user for a period of time starting before the user begins the checkout transaction and continues until a period of time after the checkout transaction is complete. Similarly, when the portable electronic device is being checked in, the photo archive feature stores images of a user for a period of time starting before the user begins the check-in transaction and continues until a period of time after the check-in transaction is completed by the user. The photo archive feature may be triggered by a sensor that senses a user being within a certain proximity to the kiosk camera 130. The kiosk administrator may then view the stored images for any transaction. The photo archive feature is space efficient, retaining only the images associated with kiosk activity. In an exemplary embodiment, the images are written to disk only once, saving both space and time.

During kiosk operations, the kiosk camera 130 (e.g., a webcam) takes a series of snapshots or photos which may be single frames or short video segments. In an exemplary embodiment, the kiosk camera 130 takes a photo every few seconds. The time between photos may be configurable by the administrator. For example, as illustrated in FIG. 8, during a checkout transaction, the kiosk camera 130 takes a series of photos (e.g., checkout snaps 810) from a period of time starting before the user begins the checkout transaction and continues until a period of time after the checkout transaction is complete. Similarly, when the portable electronic device is being checked in, the kiosk camera 130 takes a series of photos (e.g., check-in snaps 820) from a period of time starting before the user begins the check-in transaction and continues until a period of time after the check-in transaction is complete.

In an exemplary embodiment, each photo is stored to a file with a name constructed from the timestamp of time the file was stored. To illustrate, the photos may be stored in files as follows:

webcam/archive/2013/06/07
webcam/archive/2013/06/07/snap2013-06-07T00:00:02.jpg
webcam/archive/2013/06/07/snap2013-06-07T00:00:06.jpg
webcam/archive/2013/06/07/snap2013-06-07T00:00:09.jpg
webcam/archive/2013/06/07/snap2013-06-07T00:00:12.jpg
webcam/archive/2013/06/07/snap2013-06-07T00:00:15.jpg
webcam/archive/2013/06/07/snap2013-06-07T00:00:18.jpg . . .

This results is a file being created every three to four seconds in the example illustrated above, which may result in about one thousand snapshots per day. However, it will be appreciated that more or less snapshots per day are contemplated.

In an exemplary embodiment, during kiosk operations, a device eject event (e.g., checkout) and a device insert event (e.g., check-in) are noted in a table along with the timestamp of the corresponding event. An archival batch job is performed periodically, usually daily, to discard the snapshots that are not associated with check-in or checkout activity. The archival batch job finds and renames the snapshots associated with the check-in or checkout activity, and deletes the snapshots which were not renamed.

To illustrate, in an exemplary embodiment, the archival batch job pseudo code may be as follows:

function getActivityTimestamps($batch_date)
{

// select date from event where event_type = ‘eject’ or event_type =
‘insert’
// return dates as timestamp array

}
function stampToFilename($possible_stamp)
{

// example filename constructed from timestamp:
// webcam/archive/2013/06/07/snap2013-06-07T09:57:06.jpg

}
function dateToDirname($batch_date)
{

// example dirname constructed from date:
// webcam/archive/2013/06/07

}
$batch_date = “2013-06-07”;
$snap_interval = 10; // seconds before and after activity
$snap_length = 0; // zero seconds for still frame
$activity[ ] = array( );
$activity = getActivityTimestamps($batch_date);
// part one - search for possible activity snapshots and rename them
$acnt = count($activity);
for ($k = 0; $k < $acnt; $k++)
{

$stamp = $activity[$k];
$start_stamp = $stamp − $snap_interval;
$end_stamp = $stamp + $snap_interval + $snap_length;
for ($possible_stamp = $start_stamp; $possible_stamp <=

$end_stamp; $possible_stamp++)

{

$possible_filename = stampToFilename($possible_stamp);
$keep_filename = str_replace(“snap”, “keep”,
$possible_filename);
if (file_exists($possible_filename)

file_rename($possible_filename, $keep_filename);

}

}
// part two - remove unwanted snapshots
$batchDir = dateToDirname($batch_date);
exec(“rm $batchDir/snap*”);

After archival processing the archive directory for a given date is reduced to only snapshots associated with activity. To illustrate, the archive directory after the archival batch job may be as follows:

webcam/archive/2013/06/07
...
webcam/archive/2013/06/07/keep2013-06-07T10:06:28.jpg
webcam/archive/2013/06/07/keep2013-06-07T10:06:31.jpg
webcam/archive/2013/06/07/keep2013-06-07T10:06:34.jpg
webcam/archive/2013/06/07/keep2013-06-07T10:06:37.jpg
webcam/archive/2013/06/07/keep2013-06-07T10:06:40.jpg
webcam/archive/2013/06/07/keep2013-06-07T10:06:43.jpg
webcam/archive/2013/06/07/keep2013-06-07T10:06:46.jpg
...
webcam/archive/2013/06/07/keep2013-06-07T10:09:36.jpg
webcam/archive/2013/06/07/keep2013-06-07T10:09:39.jpg
webcam/archive/2013/06/07/keep2013-06-07T10:09:42.jpg
webcam/archive/2013/06/07/keep2013-06-07T10:09:45.jpg
webcam/archive/2013/06/07/keep2013-06-07T10:09:48.jpg
webcam/archive/2013/06/07/keep2013-06-07T10:09:51.jpg
webcam/archive/2013/06/07/keep2013-06-07T10:09:54.jpg . . .

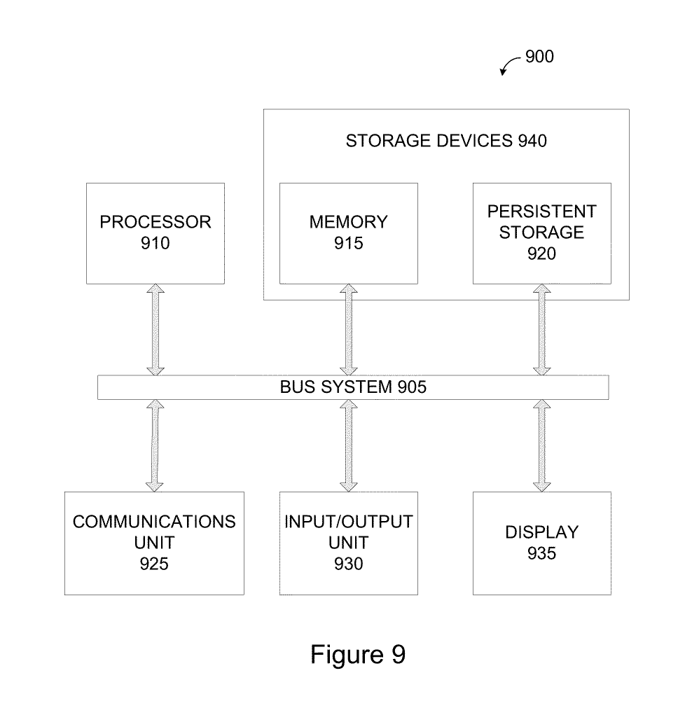

FIG. 9 illustrates a block diagram of a portion of a kiosk 900. In this example, the kiosk 900 includes a bus system 905. The bus system 905 supports communication between a processing device 910, a memory 915, a persistent storage 920, a communications unit 925, an input/output (I/O) unit 930, and a display or display interface 935. Any suitable bus or buses could be used here.

The processing device 910 processes software instructions loaded into the memory 915. The processing device 910 may include a single processor, multiple processors, one or more multi-processor cores, or other type of processor depending on the particular implementation. As an example, the processing device 910 may be implemented using a number of heterogeneous processor systems in which a main processor is present with secondary processors on a single chip. As another example, the processing device 910 may be a symmetric multi-processor system containing multiple processors of the same type. Any suitable processing device(s) could be used.

The memory 915 and the persistent storage 920 are examples of storage devices 940. A storage device is any piece of hardware capable of storing information, such as data, program code, and/or other suitable information on a temporary or permanent basis. The memory 915 may be a random access memory or other volatile or non-volatile storage device(s). The persistent storage 920 may contain one or more components or devices, such as a hard drive, flash memory, optical disc, or other persistent storage device(s). A storage device may be fixed or removable, such as when a removable hard drive or USB thumb drive is used.

The communications unit 925 provides for communications with other systems or devices. For example, the communications unit 925 could include a network interface card or a wireless transceiver. The communications unit 925 may provide communications through physical or wireless communications links.

The I/O unit 930 allows for input and output of data using other components connected to or integrated within the kiosk 900. For example, the I/O unit 930 may provide a connection for user input through a keyboard, mouse, or other input device. The I/O unit 930 may also send output to a display, printer, or other output device. The I/O unit 930 could alternatively include a keyboard, mouse, or other input or output device(s). The display 935 provides a mechanism to visually present information to a user. The display 935 could represent a touchscreen.

Program code for an operating system, applications, or other programs may be located in the storage devices 940, which are in communication with the processing device 910 through the bus system 905. Instructions forming the programs may be loaded into the memory 915 for processing by the processing device 910.

Although FIG. 9 illustrates one example of a portion of a kiosk 900 that can be used in the system 100, various changes may be made to FIG. 9. For example, FIG. 9 is simply meant to illustrate possible components in one specific implementation.

Those of ordinary skill in the art will appreciate that the hardware depicted in FIG. 9 may vary for particular implementations. The depicted example is provided for the purpose of explanation only and is not meant to imply architectural limitations with respect to the present disclosure.

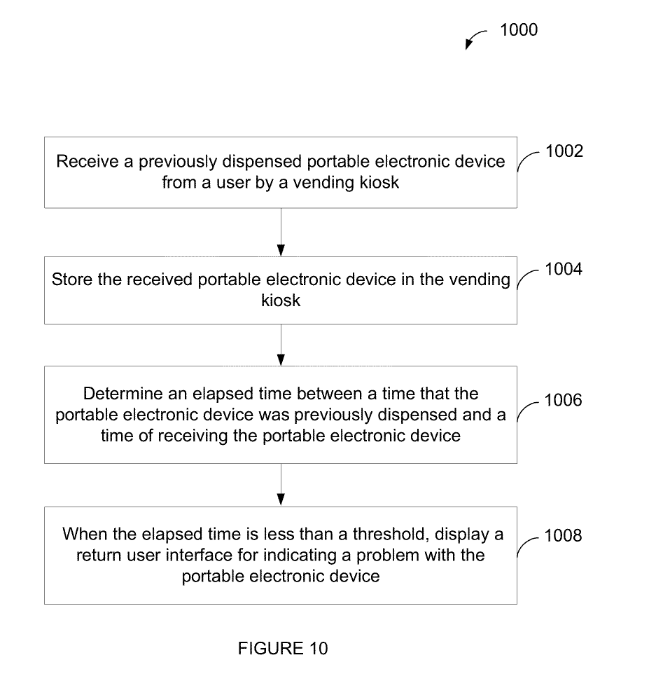

FIG. 10 illustrates an example method 1000 for checkout and return of a portable electronic device from a kiosk according to an embodiment of this disclosure. The method 1000 could, for example, be performed by the kiosk 110 of FIG. 1.

A previously dispensed portable electronic device is received by a vending kiosk from a user at step 1002, and the received portable electronic device is stored in the vending kiosk at step 1004. For example, when the user finishes using the portable electronic device (that was previously dispensed), the user performs a check-in process where the portable electronic device is received and/or identified by the kiosk 110 (e.g., scanned by and/or inserted into the kiosk 110) and thereafter stored by the kiosk to end the rental.

An elapsed time between a time that the portable electronic device was previously dispensed and a time of receiving the portable electronic device is determined at step 1006, and when the elapsed time is less than a threshold, a return user interface for indicating a problem with the portable electronic device is displayed at step 1008. For example, the kiosk 110 is configured to interpret a device checkout that is quickly followed by a device return or check-in to indicate a possible problem with the portable electronic device. In that case the kiosk 110 is configured to present a return user interface to the user such as the exemplary quick return user interface 400 illustrated in FIG. 4.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method comprising:
receiving a previously dispensed portable electronic device from a user by a vending kiosk;
storing the received portable electronic device in the vending kiosk;
determining an elapsed time between a time that the portable electronic device was previously dispensed and a time of receiving the portable electronic device; and
when the elapsed time is less than a threshold, displaying a return user interface for indicating a problem with the portable electronic device.

2. The method of claim 1, further comprising:
dispensing the stored portable electronic device in response to a user demand, the user demand associated with a verified user credential.

3. The method of claim 1, further comprising:
in response to receiving an indication of a problem with the portable electronic device, sending an electronic notification to an administrator of the vending kiosk.

4. The method of claim 3, further comprising:
based on the received indication of a problem, blocking the portable electronic device from future dispensing until the portable electronic device has been serviced.

5. The method of claim 1, further comprising:
obtaining images of the user while receiving the portable electronic device.

6. The method of claim 5, wherein obtaining images of the user further comprises:
obtaining images of the user for a duration of time that begins prior to receiving the portable electronic device and that continues until after receiving the portable electronic device.

7. The method of claim 6, further comprising:
storing each obtained image to a file with a name constructed from a timestamp of a time at which the file was stored

8. An apparatus comprising:
at least one processing device configured to:
receive a previously dispensed portable electronic device from a user;
store the received portable electronic device;
determine an elapsed time between a time that the portable electronic device was previously dispensed and a time of receiving the portable electronic device; and
when the elapsed time is less than a threshold, display a return user interface for indicating a problem with the portable electronic device.

9. The apparatus of claim 8, wherein the at least one processing device is further configured to:
dispense the stored portable electronic device in response to a user demand, the user demand associated with a verified user credential.

10. The apparatus of claim 8, wherein the at least one processing device is further configured to:
in response to receiving an indication of a problem with the portable electronic device, send an electronic notification to an administrator of the vending kiosk.

11. The apparatus of claim 10, wherein the at least one processing device is further configured to:
based on the received indication of a problem, block the portable electronic device from future dispensing until the portable electronic device has been serviced.

12. The apparatus of claim 8, wherein the at least one processing device is further configured to:
obtain images of the user while receiving the portable electronic device.

13. The apparatus of claim 12, wherein the at least one processing device is further configured to:
obtain images of the user for a duration of time that begins prior to receiving the portable electronic device and that continues until after receiving the portable electronic device.

14. The apparatus of claim 13, wherein the at least one processing device is further configured to:
store each obtained image to a file with a name constructed from a timestamp of a time at which the file was stored

15. A non-transitory computer readable storage medium comprising instructions that, when executed by at least one processing device, cause the at least one processing device to:
receive a previously dispensed portable electronic device from a user;
store the received portable electronic device;
determine an elapsed time between a time that the portable electronic device was previously dispensed and a time of receiving the portable electronic device; and
when the elapsed time is less than a threshold, display a return user interface for indicating a problem with the portable electronic device.

16. The computer readable storage medium of claim 15, further comprising instructions that, when executed by the at least one processing device, cause the at least one processing device to:
dispense the stored portable electronic device in response to a user demand, the user demand associated with a verified user credential.

17. The computer readable storage medium of claim 15, further comprising instructions that, when executed by the at least one processing device, cause the at least one processing device to:
in response to receiving an indication of a problem with the portable electronic device, send an electronic notification to an administrator of the vending kiosk.

18. The computer readable storage medium of claim 17, further comprising instructions that, when executed by the at least one processing device, cause the at least one processing device to:
based on the received indication of a problem, block the portable electronic device from future dispensing until the portable electronic device has been serviced.

19. The computer readable storage medium of claim 15, further comprising instructions that, when executed by the at least one processing device, cause the at least one processing device to:
obtain images of the user for a duration of time that begins prior to receiving the portable electronic device and that continues until after receiving the portable electronic device.

20. The computer readable storage medium of claim 19, further comprising instructions that, when executed by the at least one processing device, cause the at least one processing device to:
store each obtained image to a file with a name constructed from a timestamp of a time at which the file was stored
